(19) United States
(12) Patent Application Publication
(10) Pub. No.: US 2015/0186817 A1
(43) Pub. Date: Jul. 2, 2015

(54) Employee Value-Retention Risk Calculator

(71) Applicant: EVOLV INC., San Francisco, CA (US)

(72) Inventors: Andrew Kim, San Francisco, CA (US); Michael G. Housman, Beverly Hills, CA (US)

(21) Appl. No.: 14/484,195

(22) Filed: Sep. 11, 2014

Related U.S. Application Data
(60) Provisional application No. 61/964,272, filed on Dec. 28, 2013.

(51) Int. Cl. G06Q 10/06; G06Q 10/10

(52) U.S. Cl. CPC G06Q 10/0635; G06Q 10/105; G06Q 10/06398

(57) ABSTRACT

During an analysis technique, organization data for an organization (such as a company) and/or external data are used to calculate a performance metric and to determine retention risk for an employee. For example, the performance metric may be calculated based on revenue or productivity, and the retention risk may be determined based on an unemployment rate in a region that includes the organization or hiring trends in the region. The calculated performance metric and the determined retention risk are provided to the organization. In addition, a retention suggestion and an associated cost-benefit analysis are provided for the employee. This information may allow the organization to manage its employees, and to effectively apply limited resources to reduce retention expense and while increasing the likelihood of retaining employees.

### CROSS-REFERENCE TO RELATED APPLICATIONS

This application claims the benefit of U.S. Provisional Application No. 61/964,272, filed Dec. 28, 2013, which application is entirely incorporated herein by reference.

### BACKGROUND

### Related Art

Retaining talented employees is increasingly important for business success. While businesses previously relied on loyalty to reduce attrition, this approach is typically inadequate in a competitive and dynamic marketplace.

A variety of incentives can be used in an attempt to retain employees. For example, employees can be given bonuses or pay raises. However, giving all employees such an incentive is expensive and may not be possible given limited resources.

In addition, changes in salary may not accomplish the desired goal of retaining the employees. In particular, financial reward is but one component of employee compensation and, depending on the employee, other factors may be more important. Thus, once a minimum acceptable salary is obtained, further increases in salary may have diminished returns as a retention incentive. Furthermore, different employees may be motivated by different types of incentives, such as recognition or a feeling of accomplishment.

Consequently, it can be difficult for an organization to make business decisions as to how to allocate limited resources on an individual-specific basis to retain employees. In the absence of such employee-retention techniques, the organization may inadvertently loose talented employees, with a commensurate negative impact on profits and morale.

### SUMMARY

The present disclosure generally relates to computer-based techniques for analyzing employee value and retention risk. More specifically, the present disclosure relates to a computer-based technique for analyzing employee value and retention risk, and providing a retention suggestion and an associated cost-benefit analysis for an employee.

The disclosed embodiments relate to a computer system that analyzes employee value and retention risk. During operation, the computer system accesses, at a memory location, organization data for an organization. Then, the computer system calculates a performance metric for an employee based on the organization data. Moreover, the computer system determines retention risk for the employee based on the organization data. Next, the computer system provides the calculated performance metric and the determined retention risk. Furthermore, the computer system provides a retention suggestion and an associated cost-benefit analysis for the employee, where the cost-benefit analysis includes an expense associated with the retention suggestion and an estimated incremental retention time in response to the retention suggestion.

Note that the organization data may include: tenure of the employee at the organization, compensation of the employee, satisfaction scores associated with the employee, skills of the employee, a supervisor of the employee, a colleague of the employee, interaction among employees of the organization, and/or operations information of the organization. Additionally, the performance metric may include: revenue associated with the employee, productivity of the employee, overtime worked by the employee, adherence of the employee to a schedule, attendance of the employee, a number of employees that interact with the employee, activity of the employee, and/or satisfaction scores associated with the employee.

In some embodiments, calculating the performance metric and/or determining the retention risk involves variance decomposition to select factors in the organization data, determine their impact, and to order or cluster the factors in regression models.

Moreover, the calculating and determining operations may be repeated for multiple employees in the organization, and the calculated performance metrics and the determined retention risks for subsets of the employees are aggregated and provided. The aggregated employees may correspond to: a group in the organization, a supervisor, a location, employees having an attribute, a time interval, and/or employees associated with a customer account.

In some embodiments, the computer system accesses, at another memory location, external data for at least one other organization, and the determining of the retention risk is based on the external data. For example, the external data may include: an unemployment rate in a region that includes the organization, hiring trends in the region, retention of employees by competitors of the organization, proximity of the competitors of the organization, compensation offered by the competitors, and/or activity of the employee on a social network.

Furthermore, the calculated performance metric and the determined retention risk may be evaluated for a set of time intervals, and the calculated performance metric and the determined retention risk may correspond to variation in the set of time intervals. Alternatively or additionally, the calculated performance metric may be relative to a mean performance metric of multiple employees of the organization.

Another embodiment provides a method that includes at least some of the operations performed by the computer system.

Another embodiment provides a computer-program product for use with the computer system. This computer-program product includes instructions for at least some of the operations performed by the computer system.

Another embodiment provides a user interface for use with the computer system. This user interface provides the calculated performance metric, the determined retention risk, the retention suggestion and/or the associated cost-benefit analysis.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the disclosure are set forth with particularity in the appended claims. A better understanding of the features and advantages of the present disclosure will be obtained by reference to the following detailed description that sets forth illustrative embodiments, in which the principles of the disclosure are utilized, and the accompanying drawings (also “figure” and “FIG.” herein), of which:

FIG. 1 is a flow chart illustrating a method for analyzing employee value and retention risk in accordance with an embodiment of the present disclosure.

FIG. 2 is a flow chart illustrating the method of FIG. 1 in accordance with an embodiment of the present disclosure.

FIG. 3 is a drawing of a user interface that provides information specifying employee value and retention risk in accordance with an embodiment of the present disclosure.

FIG. 4 is a drawing of a user interface that provides information specifying employee value and retention risk in accordance with an embodiment of the present disclosure.

FIG. 5 is a drawing of a user interface that provides information specifying employee value and retention risk in accordance with an embodiment of the present disclosure.

FIG. 6 is a drawing of a user interface that provides information specifying employee value and retention risk in accordance with an embodiment of the present disclosure.

FIG. 7 is a block diagram illustrating a system that performs the method of FIGS. 1 and 2 in accordance with an embodiment of the present disclosure.

FIG. 8 is a block diagram illustrating a computer system that performs the method of FIGS. 1 and 2 in accordance with an embodiment of the present disclosure.

FIG. 9 is a block diagram illustrating a data structure that includes employee-value and retention-risk data in accordance with an embodiment of the present disclosure.

Note that like reference numerals refer to corresponding parts throughout the drawings. Moreover, multiple instances of the same part are designated by a common prefix separated from an instance number by a dash.

### DETAILED DESCRIPTION

While various embodiments of the disclosure have been shown and described herein, it will be obvious to those skilled in the art that such embodiments are provided by way of example only. Numerous variations, changes, and substitutions may occur to those skilled in the art without departing from the disclosure. It should be understood that various alternatives to the embodiments of the disclosure described herein may be employed.

Embodiments of a computer system, a technique for analyzing employee value and retention risk, and a computer-program product (e.g., software) for use with the computer system are described. During this analysis technique, organization data for an organization (such as a company) and/or external data are used to calculate a performance metric and to determine retention risk for an employee. For example, the performance metric may be calculated based on revenue or productivity, and the retention risk may be determined based on an unemployment rate in a region that includes the organization or hiring trends in the region. The calculated performance metric and the determined retention risk are provided to the organization. In addition, a retention suggestion and an associated cost-benefit analysis are provided for the employee.

Thus, by calculating the employee value and retention risk, the analysis technique may allow the organization to make better business decisions. For example, the organization may be able to dynamically identify a valuable employee who is at risk of leaving so that corrective action can be taken. Moreover, the analysis technique may assist the organization in determining how to use limited resources to retain the employee and/or whether it is cost-effective to try to retain the employee. In these ways, the analysis technique may assist the organization in managing its employees. Consequently, the analysis technique may facilitate business success of the organization and, thus, commercial activity.

Note that the analysis technique is not an abstract idea. In particular, the quantitative analysis included in the analysis technique is not: a fundamental economic principle, a human activity (the calculations involved in the operations in the analysis technique significantly exceed those of a human because of the very large number of parameters or factors considered), and/or a mathematical relationship/formula. Moreover, the analysis technique amounts to significantly more than an alleged abstract idea. In particular, the analysis technique improves the functioning of a computer or the computer system that executes software and/or implements the analysis technique. For example, the analysis technique: speeds up computation of the performance metric, the retention risk, the retention suggestions and the cost-benefit analysis; reduces memory consumption when performing the computations; improves reliability of the computations (as evidenced by improved retention); reduces network latency; improves the user-friendliness of a user interface that displays results of the computations; and/or improves other performance metrics related to the function of the computer or the computer system.

In the discussion that follows, an employee may include: an individual or a person. Furthermore, an ‘organization’ should be understood to include: businesses, for-profit corporations, non-profit corporations, groups of individuals, sole proprietorships, government agencies, partnerships, etc.

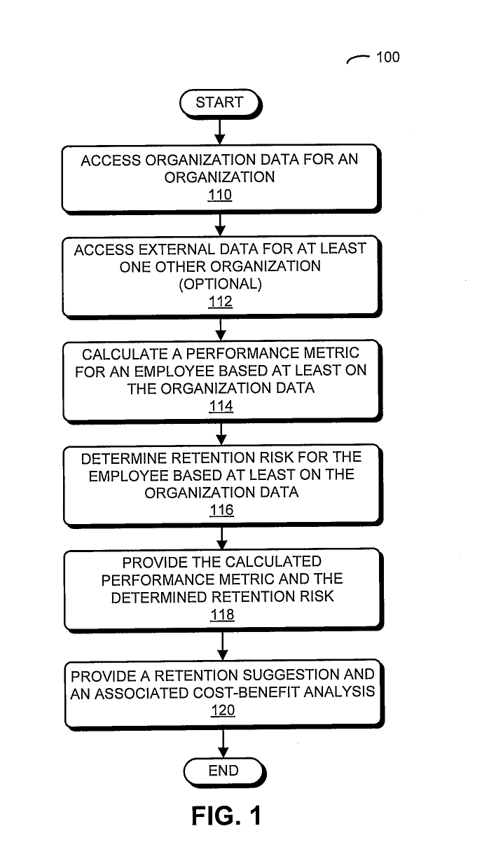

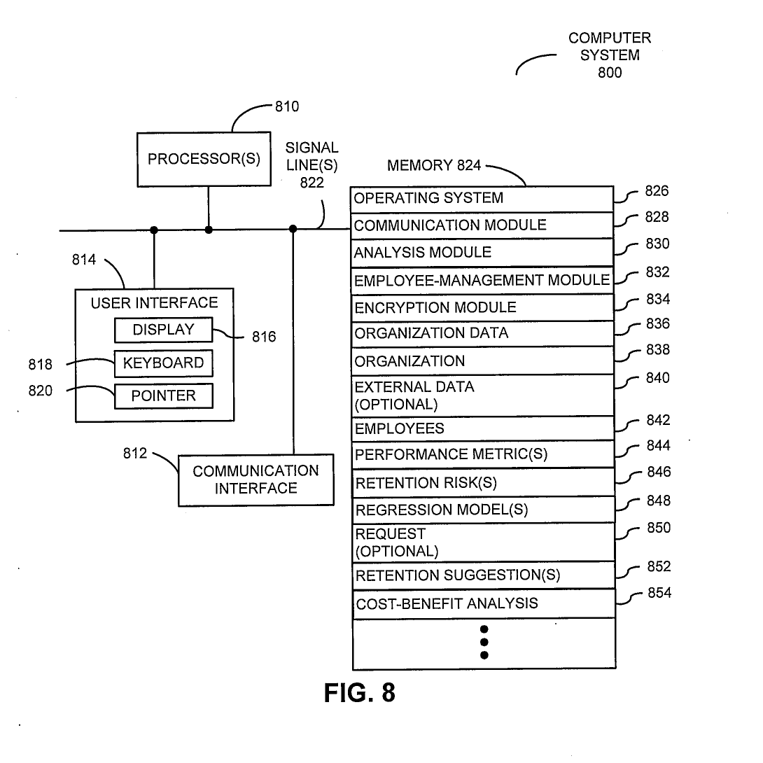

We now describe embodiments of the analysis technique. FIG. 1 presents a flow chart illustrating a method 100 for analyzing employee value and retention risk, which may be performed by a computer system (such as computer system 800 in FIG. 8). During operation, the computer system accesses, at a memory location, organization data for an organization (operation 110). For example, the computer system may access the organization data of a company via a data portal using a network (such as the Internet). Note that the organization data may include human-resources data and/or operations data. In particular, the organization data may include: tenure of the employee at the organization (such as the hire date), attendance of the employee (such as how often the employee is sick or late for work), compensation of the employee, satisfaction scores associated with the employee (such as rankings provided by a customer, a manager or other employees, a trainer or coach, etc.), skills of the employee, a supervisor of the employee, a colleague of the employee, interaction among employees of the organization (such as email, telephone calls or text messages among the employees), metadata about the employee (such as educational or work experience attributes), and/or operations information of the organization (such as products or services that are fabricated or sold as a function of time).

Then, the computer system calculates a performance metric for an employee based at least on the organization data (operation 114). Note that the performance metric may include: revenue associated with the employee, productivity of the employee, overtime worked by the employee, adherence of the employee to a schedule, attendance of the employee, a number of employees that interact with the employee, activity of the employee (such as words typed per minute or keystrokes on user interface), and/or satisfaction scores associated with the employee (rankings provided by a customer, a manager or other employees, a trainer or coach, etc.). For example, the performance metric may assess the influence of the employee in at least a subset of the organization based on the number of times the employee is included in the address list of emails or text messages, or the number of times other employees call the employee. In particular, the performance metric may use a social graph to map the interactions among employees of the organization, and central nodes (with lots of edges may have higher performance metrics than other nodes).

Alternatively or additionally, the performance metric may assess the impact of the employee on revenue or profit of the organization. For example, the calculated performance metric may be relative to a mean performance metric of multiple employees of the organization. In some embodiments, productivity of multiple employees is fit to a function (such as Gaussian), and the performance metric may have values representing different portions of the distribution (such as a highest value for the top 5 or 10% of the employees).

Moreover, the computer system determines retention risk for the employee based at least on the organization data (operation 116). In some embodiments, the computer system optionally accesses, at another memory location, external data for at least one other organization (operation 112), and the determining of the retention risk is based on the external data. For example, the external data may include: an unemployment rate in a region that includes the organization (such as a city or a state), hiring trends in the region (such as a number of job postings or hiring by one or more competitors of the organization), retention of employees by competitors of the organization, proximity of the competitors of the organization (such as the opening nearby of a new factory), compensation offered by the competitors, and/or activity of the employee on a social network (such as posting by the employee on an employment forum or updates to the employee's profile on an employment-related social network).

As described further below, the calculated performance metric and/or the determined retention risk may be evaluated for a set of time intervals, and the calculated performance metric and/or the determined retention risk may correspond to variation during the set of time intervals (such as a second derivative as a function of time, which may indicate volatility and, thus, may be predictive for change). For example, the retention risk may be the second derivative as a function of time of hiring by competitors of the organization of one or more individuals who have similar education or work experience as the employee (as indicated by attributes or metadata associated with the employee in the organization data) during the set of time intervals (which each may have a duration of one day or a week). Peaks in the retention risk exceeding a threshold (such as 2-3× of the long-term average retention-risk value) may indicate that the employee's employment state is likely to change (i.e., that they are at risk of leaving the organization).

In some embodiments, calculating the performance metric (operation 114) and/or determining the retention risk (operation 116) involves variance decomposition (into a portion of the variance associated with known sources and another portion of the variance associated with unknown sources) to select factors in the organization data, determine their impact, and to order or cluster the factors in regression models. For example, variance decomposition may perform regression to assess the importance and to order the factors in a polynomial, which may be a liner combination of the factors raised to associated exponents n and multiplied by associated amplitude weights wᵢ (however, a wide variety of linear and nonlinear functions may be used). In particular, using the entropy, a set of factors may be identified in the organization data and/or the optional external data. Then, a series of regression models may be built and evaluated using a training subset of the organization data and/or the optional external data. In these regression models, factors may be removed one at a time, and the remaining factors may be reordered. These permutations and combinations on subsets of the set of factors may provide a table of predictions for the different regression models (i.e., statistical comparison between predictions of the regression models for a test subset of the organization data and/or optional external data relative to the training subset). The average model performance for the factors, the cross-correlations among the factors and/or the ordering of the factors in these predictions may be used to select the polynomial (factors, exponents n and amplitude weights wᵢ) using to calculate the performance metric and/or to determine the retention risk. Thus, variance decomposition may allow the number of factors in the organization data and/or the optional external data to be pruned to reduce the risk of over fitting.

While the preceding discussion illustrated the use of variance decomposition, more generally a feature selection or a feature extraction technique (including a more general version of variance decomposition) may be used in operations 114 and/or 116 to assess the impact of different features on the overall quality of a predictive model, thereby allowing a subset of the features (or possible predictors) to be used in a predictive model. Thus, the specific embodiment of variance decomposition is used for purposes of illustration only, and one or more other feature selection or feature extraction techniques may be used. However, the use of such feature selection or feature extraction techniques in method 100 is optional.

Moreover, the calculating and determining operations (operations 114 and 116) may be repeated for multiple employees in the organization, and the calculated performance metrics and the determined retention risks for subsets of the employees may be aggregated and provided. The aggregated employees may correspond to: a group in the organization (such as a department), a supervisor of the employees, a location, employees having an attribute (such as a job title, an educational background or skill set), a time interval (such as one week, a month, six months, a year, etc.), and/or employees associated with a customer account (such as a particular client). This aggregation operation may reduce noise in the results, and may allow the analysis technique to provide actionable feedback on trends in different subsets of the organization (such as different groups or employees that work for the same manager or supervisor).

Next, the computer system provides the calculated performance metric and the determined retention risk (operation 118). For example, the computer system may provide the calculated performance metric and the determined retention risk to a manager or a supervisor of the employee in the organization. Alternatively or additionally, the computer system may provide the calculated performance metric and the determined retention risk to a representative of human resources for the organization.

Furthermore, the computer system provides a retention suggestion and an associated cost-benefit analysis for the employee (operation 120), where the cost-benefit analysis includes an expense associated with the retention suggestion and an estimated incremental retention time in response to the retention suggestion. For example, the retention suggestion may be to offer additional training opportunities to the employee to help them improve their skills. Thus retention suggestion may cost $20,000, but may be predicted to keep the employee from leaving for several months, which may more than offset the incremental expense (thereby justifying the use of the retention suggestion). More generally, the retention suggestion may include an action that may keep the employee from leaving (such as: a one-time bonus, a pay increase, a promotion, a change in title, a change in work responsibility, additional training, changing the employee's supervisor, recognition among other employees, etc.). The retention suggestion and/or the cost-benefit analysis may be provided to the manager or the supervisor of the employee in the organization, and/or to the representative of human resources for the organization.

The combination of the calculated performance metric, the determined retention risk, the retention suggestion and/or the cost-benefit analysis may provide the manager or the representative information with which to make informed decisions about managing the employees of the organization, thereby allowing the organization to reduce attrition and the associated retention cost. In particular, method 100 may be used to identify, on an individual-specific basis, who are the flight risks from an organization and how best to intervene to prevent the loss of valuable employees. (However, the aggregate impact on more than one employee may be used as feedback to revise or improve the recommendations. Thus, the computer system may track the impact of previous recommendations for other employees, and this information may be used as feedback to improve subsequent recommendation(s) for one or more other employees.) This capability may allow the organization to retain key personnel (e.g., employees with large values of the performance metric), which may facilitate continued success of the organization. For example, the organization may use the information provided by the analysis technique to guide: training of the employee, termination of the employee (or other employees), improved matching of the employee and their supervisor, retention efforts, etc. Alternatively or additionally, there may be a trend in which a particular supervisor is effective (in terms of productivity), but has high attrition with new employees. In this case, the analysis technique may provide a recommendation (the retention suggestion) that the employee (who may be a new employee) be assigned to a different supervisor or manager.

Note that the analysis technique may be implemented by a third party (such as a separate company) that provides a service to the organization. Alternatively, the organization may use the analysis technique to manage its own employees. In some embodiments, the analysis technique is included as a service that compliments recruiting efforts, so that a new hire does not leave the organization. In these embodiments, the analysis technique may be viewed as a form of insurance for the recruiter and/or the organization.

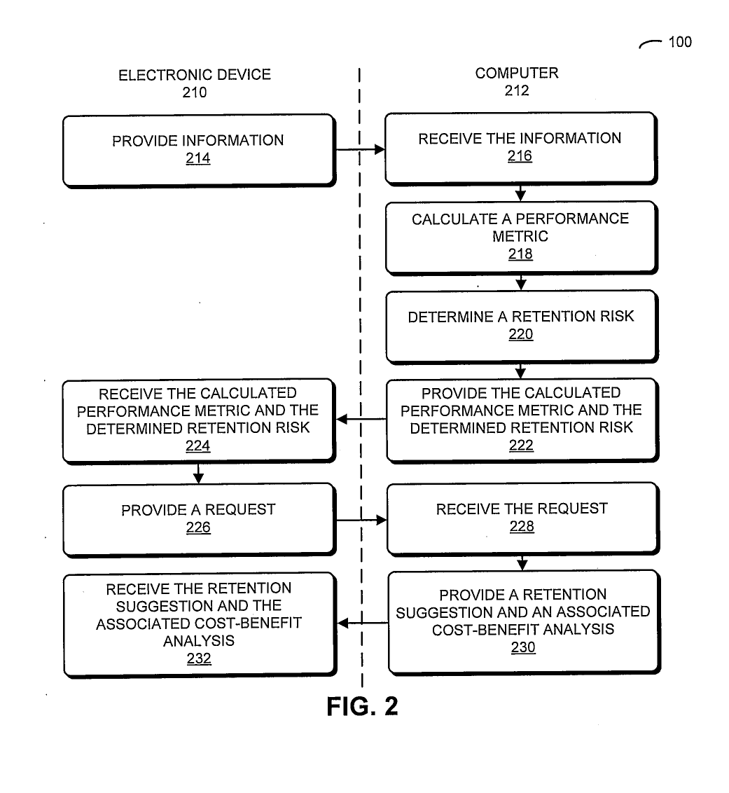

In an exemplary embodiment, the analysis technique is implemented using one or more electronic devices (such as a computer, a server or a computer system) and one or more computers (such as a server or a computer system), which communicate through a network, such as a cellular-telephone network and/or the Internet. This is illustrated in FIG. 2, which presents a flow chart illustrating method 100 (FIG. 1).

During the method, electronic device 210 may provide (operation 214) and computer 212 may receive (operation 216) information, such as the organization data for the organization and/or the optional external data.

Then, computer 212 may calculate the performance metric (operation 218) for the employee. Moreover, computer 212 may determine the retention risk (operation 220) for the employee. Operations 218 and 220 may be repeated multiple times to determine one or more regression models.

Next, computer 212 may provide (operation 222) and electronic device 210 may receive (operation 224) the calculated performance metric and the determined retention risk. Furthermore, a user of electronic device 210 may provide (operation 226) and computer 212 (operation 228) may receive a request. In response, computer 212 may provide (operation 230) and electronic device 210 may receive (operation 232) the retention suggestion and the associated cost-benefit analysis for the employee.

In some embodiments of method 100 (FIGS. 1 and 2), there are additional or fewer operations. Moreover, the order of the operations may be changed, and/or two or more operations may be combined into a single operation.

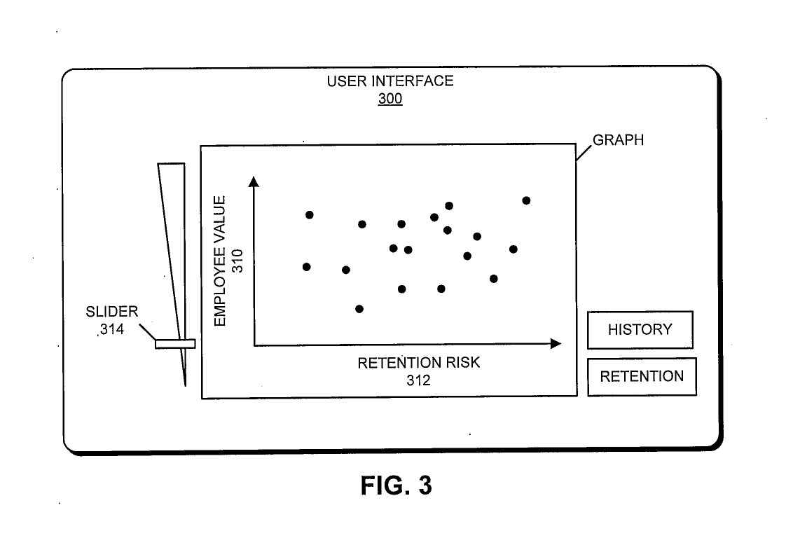

As described previously, in an exemplary embodiment the analysis technique may allow the value of an employee's contribution to a company and their flight or retention risk to be used by companies that are seeking to maintain and maximize their human capital (post hiring) while reducing their operational expenses (i.e., for competitive advantage). As described further below with reference to FIGS. 3-6, the results of the analysis technique may be used to place employees along a graphical ‘heat map’ in which their contribution (or performance metrics) is on one axis and their retention risk is along the other, thereby illustrating the tradeoff between these parameters. Employers can then easily and quickly assess the state of their workforce, and intervene when high-value employees are at a high flight-risk.

In general, employers face problems with not only employee retention, but in retaining the talent that drives the most value to their companies. It would be advantageous if an employer could focus their efforts on the retention of high-value talent after these employees are hired. In the analysis technique, this is facilitated by calculating the value of an employee (the performance metric) and their flight risk (the retention risk).

The value of an employee may have an intangible and tangible element. For example, an employee's contribution to the workplace or the work environment can be difficult to quantify. It is often assessed intuitively. However, it may be possible to monitor the interactions among employees via email, text and/or telephone communication, as well as based on the proximity of the employees to each other (e.g., an application installed on the employee's cellular telephones may track how close the employees are to each other, and how often this occurs). The tangible value of an employee may be calculated based on performance indicators, such as: tenure and consistency.

The flight risk of an employee may be more difficult to determine because employee dissatisfaction may not be outwardly visible during direct interaction with the employee. However, the flight risk may be embedded in their performance data. For example, sudden changes (downward or upward) may indicate that the employee is either dissatisfied or is trying to impress a new employer. Similarly, economic data (such as the optional external data) may indicate the state of the market for the employee, and thus may indicate how tempting or numerous are any competing offers (or prospective offers) for the employee.

As shown in FIG. 3, which presents a drawing of a user interface 300, employee value 310 and retention risk 312 may be displayed graphically for one or more employees to user of the human-resources software, such as a manager at the organization or a representative of human resources. This may allow the relative value and retention risk for a given employee to be assessed.

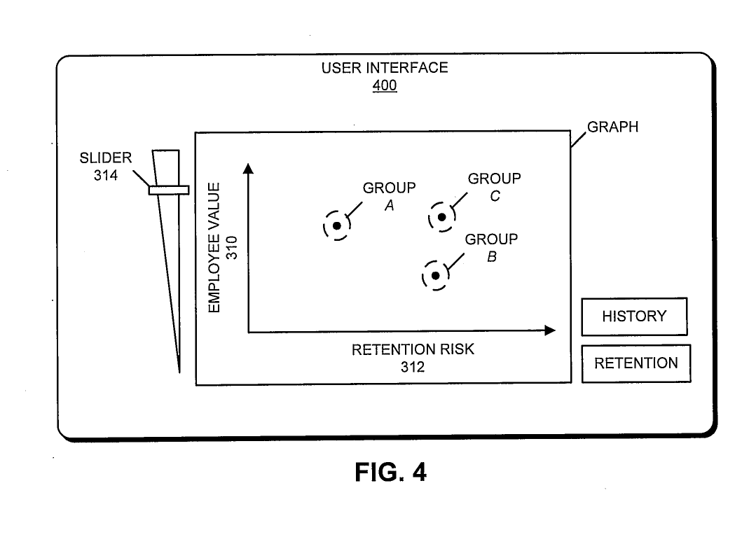

By activating an icon, such as by clicking on or touching a slider, the user may change the scale in the organization that is presented. For example, by moving slider 314, the user may view the aggregate value and retention risk for employees in different groups or departments in the organization. Alternatively, the user may view the aggregate value and retention risk for the employees of different managers. This is shown in FIG. 4, which presents a drawing of a user interface 400. Note that data points in user interface 300 (FIG. 3) may be color coded to indicate associations of particular employees with different groups in the organization and/or with different managers.

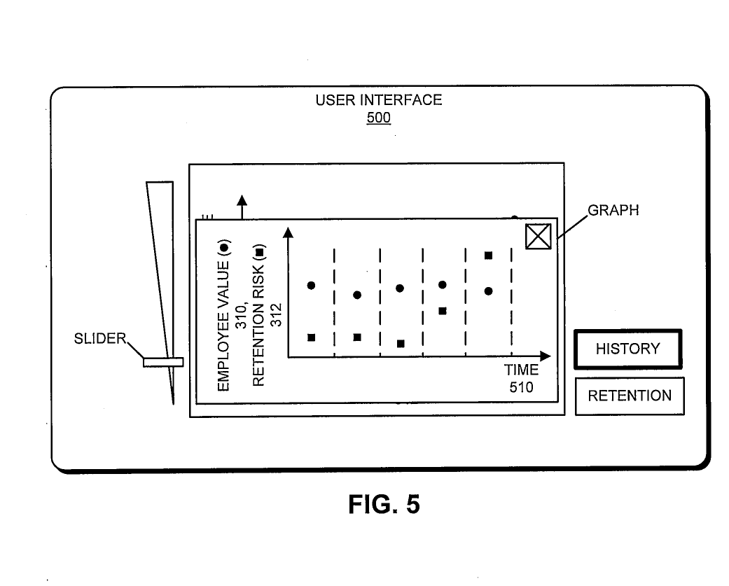

In addition, by right-clicking on or touching a data point in user interface 300 (FIG. 3) (or by selecting the data point for an employee and activating a ‘history’ icon), a menu may be displayed. Selecting a ‘history’ option may result in the display of a graph of employee value 310 and retention risk 312 as a function of time 510 (FIG. 5) for an employee. This is shown in FIG. 5, which presents a drawing of a user interface 500. This user interface may allow the user to visually assess trends for the employee.

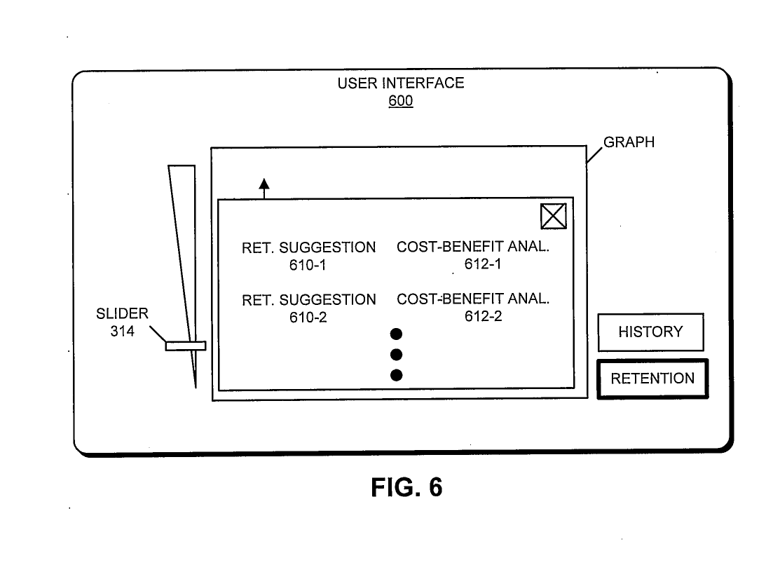

Alternatively, by right-clicking on or touching a data point in user interface 300 (FIG. 3) (or by selecting the data point for an employee and activating a ‘retention’ icon), and then selecting a ‘retention’ option, may result in the display of one or more retention suggestions 610 (FIG. 6) and an associated cost-benefit analysis 612 (FIG. 6) for the employee. This is shown in FIG. 6, which presents a drawing of a user interface 600. Note that the one or more retention suggestions 610 may be ordered or ranked. This information may present options for the user to use in retaining the employee. In addition, the displayed cost-benefit analysis 612 may allow the user to determine whether a particular retention suggestion is worthwhile or pays for itself. User interface 600 may include intuitive information to assist the user in this regard. For example, retention suggestions that are likely to be worthwhile (either financially or per predefined user criteria) may have a different color than those that are marginal or unlikely to be worthwhile.

Using the information provided by the analysis technique, the user may be able to identify, with high accuracy, the employees that are at risk of terminating or self-selecting out. This feedback can be weighed against the employees' contribution value to the organization. Collectively, this information may allow employers to make informed and intelligent decisions the employee quits or leaves the organization.

In an exemplary embodiment, the analysis technique generates and maintains an econometric regression model. This regression model uses consistent and high-velocity data streams that are repeatedly updated to conduct analyses and to maintain calibration. For example, the regression model may be updated in near real-time (such as hourly, daily or weekly). The data-stream and machine-learning components used by the analysis technique to create a scalable and robust solution.

During the analysis technique, employee value (such as productivity in answering customer telephone calls or in fabricating a product) may be calculated using deviations of performance of a single employee from the population averages for the organization. A Gaussian distribution may be used. The employees that are considered to be medium-value performers would cluster at the average value of the distribution, and high- and low-value performing employees would be in the tails of the distribution.

Employee flight risk may be determined using multiple levels of regression models. The explanatory variables in the regression models that predict the likelihood of exit may be calculated using performance data feeds (e.g., from the organization data) and the volatility of their daily performance. Moreover, the volatility may use predetermined bounds of inherent volatility (such as 2-3× a long-term average value). Alternatively or additionally, the first and second-order derivative as a function of time of their daily performance may be calculated and the slope and direction may be used as predictors.

As shown in FIGS. 3-6, the calculated employee value and flight risk may then be combined and displayed as a scatterplot so that employers can identify high-flight-risk and high-value employees. This graph may also provide a dynamic and a real-time view of the state of the employer's workforce, as well as trends among their employees.

For example, company ABC may provide the organization data to a provider of the analysis technique, including: employee-level work location, job title, overtime hours, and the employee's supervisor. In addition, the provider may receive daily customer-satisfaction scores for the employees and the number of sales conversions. This data may be combined (hourly or daily) with existing organization data, and with regional monthly unemployment levels and weekly gas prices (the optional external data).

During the analysis technique, variance decomposition may determine that gas price is non-predictive, so this factor may not be used in subsequent predictive analysis. However, the square of overtime may have been identified as predictive, and this factor may have been included in the regression model.

Using the regression model (which may be used for one employee or multiple employees), and the aforementioned factors in the organization data and the optional external data, the performance metric and retention risk of employee Bob Smith at the company may be determined. The results may indicate that Bob's customer satisfaction performance during the last week has been extremely (relative to his historic baseline) varied, and that his overtime has reduced. This may indicate an 82% increased likelihood that Bob may leave the company within a week.

However, Bob may be a high performing employee. In particular, company ABC may consider employees that produce more widgets per hour valuable. Based on his average productivity in this regard (holding constant factors such as work location or job type), Bob may be in the top 5% of employees. Consequently, a retention suggestion may be provided. This retention suggestion may indicate that by giving Bob a financial award as an ‘outstanding performer’ is likely to ensure that he stays at the company for at least six months, and that the incremental cost is more than offset by his high productivity.

Note that the variance decomposition may involve Shapley and Owen values. In particular, the marginal contributions of the variables to the goodness of fit of regression models with different variables and variable orders in subgroups or partitions of the variables may be calculated. Then, the average marginal contributions for the variables may be computed, thereby specifying their relative importance or contributions. This information may be used to prune the number of variables and/or to select the variable order in the regression models.

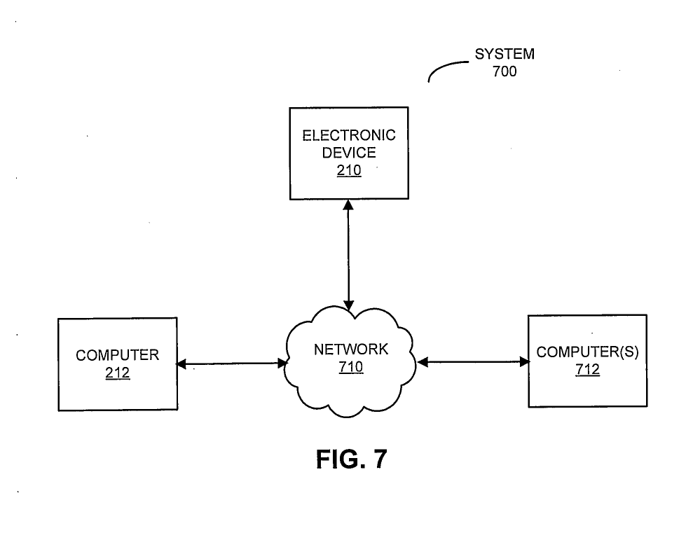

We now describe embodiments of a system and the computer system, and their use. FIG. 7 presents a block diagram illustrating a system 700 that can be used, in part, to perform operations in method 100 (FIGS. 1 and 2). In this system, during the analysis technique a user of electronic device 210 may use a software product, such as a software application that is resident on and that executes on electronic device 210. (Alternatively, the user may interact with a web page that is provided by computer 212 via network 710, and which is rendered by a web browser on electronic device 210. For example, at least a portion of the software application may be an application tool that is embedded in the web page, and which executes in a virtual environment of the web browser. Thus, the application tool may be provided to electronic device 210 via a client-server architecture.) This software application may be a standalone application or a portion of another application that is resident on and which executes on electronic device 210 (such as a software application that is provided by computer 212 or that is installed and which executes on electronic device 210). In an exemplary embodiment, the software product may include human-resources software, which is used by a manager or a representative of human resources.

During the analysis technique, the user of electronic device 210 may provide, via network 710, the organization data for the organization to computer 212. In addition, computer 212 may access, via network 710, the optional external data from one or more other computer(s) 712. The organization data and/or the optional external data may be regularly or periodically received by computer 212, such as: hourly, daily or weekly.

Then, computer 212 may calculate the performance metric for the employee. Moreover, computer 212 may determine the retention risk for the employee. These operations may be repeated multiple times to determine one or more regression models for the employee and/or to determine regression models for multiple employees.

Next, computer 212 may provide, via network 710, the calculated performance metric and the determined retention risk to electronic device 210. Furthermore, the user of electronic device 210 may provide, via network 710, the request. In response, computer 212 may access in a computer-readable memory, and then may provide, via network 710, the retention suggestion and the associated cost-benefit analysis for the employee to electronic device 210. The user may use this information to make decisions as to how to manage, incentivize and/or retain the employee.

Note that information in system 700 may be stored at one or more locations in system 700 (i.e., locally or remotely). Moreover, because this data may be sensitive in nature, it may be encrypted. For example, stored data and/or data communicated via network 710 may be encrypted using symmetric and/or asymmetric encryption techniques (such as public-private key encryption).

FIG. 8 presents a block diagram illustrating a computer system 800 that performs methods 100 (FIGS. 1 and 2), which may correspond to or may include computer 212 (FIGS. 2 and 7). Computer system 800 includes one or more computer processing units or computer processors 810, a communication interface (or a network interface) 812, a user interface 814, and one or more signal lines 822 coupling these components together. Note that the one or more processors 810 may support parallel processing and/or multi-threaded operation, the communication interface 812 may have a persistent communication connection, and the one or more signal lines 822 may constitute a communication bus. Examples of operations performed by one or more processors 810 may include: fetch, decode, execute, and writeback. Moreover, the user interface 814 may include: a display 816 (such as a touch-sensitive display), a keyboard 818, and/or a pointer 820, such as a mouse.

Memory 824 in computer system 800 may include volatile memory and/or non-volatile memory. More specifically, memory 824 may include: ROM, RAM, EPROM, EEPROM, flash memory, one or more smart cards, one or more magnetic disc storage devices, and/or one or more optical storage devices. Memory 824 may store an operating system 826 that includes procedures (or a set of instructions) for handling various basic system services for performing hardware-dependent tasks. Memory 824 may also store procedures (or a set of instructions) in a communication module 828. These communication procedures may be used for communicating with one or more computers and/or computer servers (which are sometimes referred to as ‘servers’), including computers and/or servers that are remotely located with respect to computer system 800.

Memory 824 may also include multiple program modules (or sets of instructions), including: analysis module 830 (or a set of instructions), employee-management module 832 (or a set of instructions) and/or encryption module 834 (or a set of instructions). Note that one or more of these program modules (or sets of instructions) may constitute a computer-program mechanism.

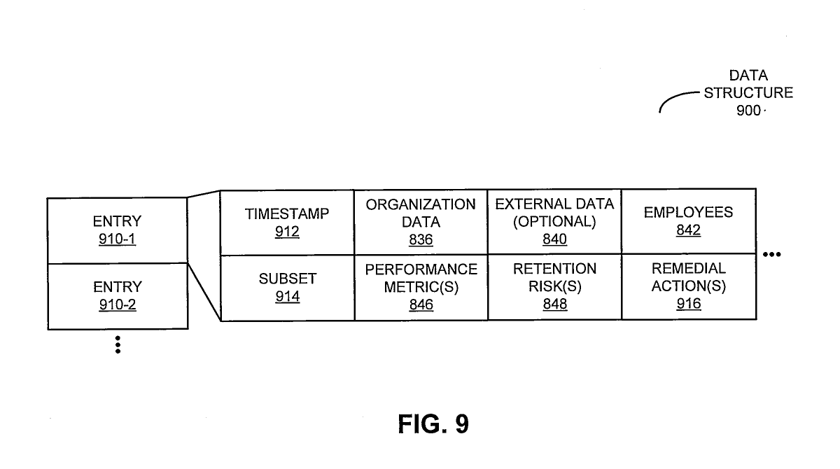

During the analysis technique, analysis module 830 may receive, via communication interface 812 and communication module 828, organization data 836 for an organization 838 and/or optional external data 840. (Alternatively or additionally, analysis module 830 may access, at one or more memory locations in memory 824, organization data 836 and/or optional external data 840.) As noted previously, organization data 836 and/or optional external data 840 may be regularly or periodically received by computer system 800. As shown in FIG. 9, which presents a block diagram illustrating data structure 900, this information may be stored in a data structure (such as a database or an another type of data structure) for subsequent analysis. In particular, data structure 900 includes entries 910, such as organization data 836 and/or optional external data 840 at different time stamps (such as timestamp 912). As described further below, this information may be analyzed one or more times for different employees 842 in subsets (such as subset 914) of organization 838 (FIG. 8) to determine one or more performance metrics 844, one or more retention risks 846 and/or one or more remedial actions 916 (such as one or more retention suggestions 852 and one or more cost-benefit analyses 854 in FIG. 8).

Referring back to FIG. 8, analysis module 830 may calculate one or more performance metrics 844 for one of employees 842. Moreover, analysis module 830 may determine one or more retention risks 846 for the employee. As noted previously, these operations may be repeated multiple times to determine one or more regression models 848 for the employee and/or to determine one or more regression models 848 for employees 842.

Next, employee-management module 832 (such as human-resources software) provides, via communication module 828 and communication interface 812, one or more performance metric 844 and one or more retention risks 846 for the employee. Furthermore, employee-management module 832 (such as human-resources software) provides, via communication module 828 and communication interface 812, one or more retention suggestions 852 and one or more cost-benefit analyses 854 for the employee. The latter information may be in response to an optional request 850 that is received, via communication interface 812 and communication module 828, from a user. As noted previously, the user may use this information to make decisions as to how to manage, incentivize and/or retain the employee.

Because information used in the analysis technique may be sensitive in nature, in some embodiments at least some of the data stored in memory 824 and/or at least some of the data communicated using communication module 828 is encrypted or decrypted using encryption module 834.

Instructions in the various modules in memory 824 may be implemented in: a high-level procedural language, an object-oriented programming language, and/or in an assembly or machine language. Note that the programming language may be compiled or interpreted, e.g., configurable or configured, to be executed by the one or more processors 810. (Thus, when one or more of processors 810 executes one or more of the modules in memory 824, the one or more processors 810 may be considered to be ‘programmed’ to perform the computational technique.)

Although computer system 800 is illustrated as having a number of discrete items, FIG. 8 is intended to be a functional description of the various features that may be present in computer system 800 rather than a structural schematic of the embodiments described herein. In some embodiments, some or all of the functionality of computer system 800 may be implemented in one or more application-specific integrated circuits (ASICs) and/or one or more digital signal processors (DSPs). In some embodiments, computer system 800 is implemented using a distributed computing system, such as cloud computing.

Computer system 800, as well as electronic devices, computers and servers in system 800, may include one of a variety of devices capable of manipulating computer-readable data or communicating such data between two or more computing systems over a network, including: a personal computer, a laptop computer, a tablet computer, a mainframe computer, a portable electronic device (such as a cellular telephone or PDA), a server, and/or a client computer (in a client-server architecture). Moreover, network 710 (FIG. 7) may include: the Internet, World Wide Web (WWW), an intranet, a cellular-telephone network, LAN, WAN, MAN, or a combination of networks, or other technology enabling communication between computing systems.

Electronic device 210 (FIGS. 2 and 7), computer 212 (FIGS. 2 and 7), system 700 (FIG. 7), computer system 800 and/or data structure 900 (FIG. 9) may include fewer components or additional components. Moreover, two or more components may be combined into a single component, and/or a position of one or more components may be changed. In some embodiments, the functionality of electronic device 210 (FIGS. 2 and 7), computer 212 (FIGS. 2 and 7), system 700 (FIG. 7), computer system 800 and/or data structure 900 (FIG. 9) may be implemented more in hardware and less in software, or less in hardware and more in software, as is known in the art.

While the preceding embodiments illustrated the use of the analysis technique for employees, in other embodiments the analysis technique is used with individuals who are not paid by the organization. Thus, the individuals may include volunteers or individuals whose compensation is other than salary. For example, one of the individuals may receive compensation in the form of services, free products or via barter.

Furthermore, while regression models and variance decomposition were used as illustrative examples in the analysis technique, a wide variety of supervised and/or unsupervised learning techniques may be used in conjunction with the analysis technique. For example, linear and/or nonlinear predictive models may be determined from the organization data and/or the optional external data using: support vector machines, neural networks, classification and regression trees, Bayesian statistics, regression analysis, logistic regression, and/or another machine-learning technique.

In the preceding description, we refer to ‘some embodiments.’ Note that ‘some embodiments’ describes a subset of all of the possible embodiments, but does not always specify the same subset of embodiments.

While preferred embodiments of the present disclosure have been shown and described herein, it will be obvious to those skilled in the art that such embodiments are provided by way of example only. It is not intended that the disclosure be limited by the specific examples provided within the specification. While the disclosure has been described with reference to the aforementioned specification, the descriptions and illustrations of the embodiments herein are not meant to be construed in a limiting sense. Numerous variations, changes, and substitutions will now occur to those skilled in the art without departing from the disclosure. Furthermore, it shall be understood that all aspects of the disclosure are not limited to the specific depictions, configurations or relative proportions set forth herein which depend upon a variety of conditions and variables. It should be understood that various alternatives to the embodiments of the disclosure described herein may be employed in practicing the disclosure. It is therefore contemplated that the disclosure shall also cover any such alternatives, modifications, variations or equivalents. It is intended that the following claims define the scope of the disclosure and that methods and structures within the scope of these claims and their equivalents be covered thereby.

What is claimed is:

1. A computer-implemented method for analyzing employee value and retention risk, the method comprising:
accessing, at a memory location, organization data for an organization;
using a computer processor that is coupled to the memory location and programmed to analyze the employee value and the retention risk, calculating a performance metric for an employee based on the organization data;
using the organization data, determining the retention risk for the employee;
providing the calculated performance metric and the determined retention risk; and
providing a retention suggestion and an associated cost-benefit analysis for the employee, wherein the cost-benefit analysis includes an expense associated with the retention suggestion and an estimated incremental retention time in response to the retention suggestion.

2. The method of claim 1, wherein the organization data includes one of: tenure of the employee at the organization, compensation of the employee, satisfaction scores associated with the employee, skills of the employee, a supervisor of the employee, a colleague of the employee, interaction among employees of the organization, and operations information of the organization.

3. The method of claim 1, wherein the performance metric includes one of: revenue associated with the employee, productivity of the employee, overtime worked by the employee, adherence of the employee to a schedule, attendance of the employee, a number of employees that interact with the employee, activity of the employee, and satisfaction scores associated with the employee.

4. The method of claim 1, wherein at least one of calculating the performance metric and determining the retention risk involves variance decomposition to select factors in the organization data, determine the impact of the factors, and to cluster the factors in regression models.

5. The method of claim 1, wherein the calculating and determining operations are repeated for multiple employees in the organization; and
wherein the calculated performance metrics and the determined retention risks for subsets of the employees are aggregated and provided.

6. The method of claim 5, wherein the aggregated employees correspond to one of: a group in the organization, a supervisor, a location, employees having an attribute, a time interval, and employees associated with a customer account.

7. The method of claim 1, wherein the method further comprises accessing, at another memory location, external data for at least one other organization; and
wherein the determining of the retention risk is based on the external data.

8. The method of claim 7, wherein the external data includes one of: an unemployment rate in a region that includes the organization, hiring trends in the region, retention of employees by competitors of the organization, proximity of the competitors of the organization, compensation offered by the competitors, and activity of the employee on a social network.

9. The method of claim 1, wherein the calculated performance metric and the determined retention risk are evaluated for a set of time intervals; and
wherein the calculated performance metric and the determined retention risk correspond to variation in the set of time intervals.

10. The method of claim 1, wherein the calculated performance metric is relative to a mean performance metric of multiple employees of the organization.

11. A computer-program product for use in conjunction with a computer system, the computer-program product comprising a non-transitory computer-readable storage medium and a computer-program mechanism embedded therein to analyze employee value and retention risk, the computer-program mechanism including:
instructions for accessing, at a memory location in the computer system, organization data for an organization;
instructions for calculating a performance metric for an employee based on the organization data, wherein the calculation uses a computer processor in the computer system that is coupled to the memory location and programmed to analyze the employee value and the retention risk;
instructions for determining, using the organization data, the retention risk for the employee;
instructions for providing the calculated performance metric and the determined retention risk; and
instructions for providing a retention suggestion and an associated cost-benefit analysis for the employee, wherein the cost-benefit analysis includes an expense associated with the retention suggestion and an estimated incremental retention time in response to the retention suggestion.

12. The computer-program product of claim 11, wherein the calculating and determining operations are repeated for multiple employees in the organization; and
wherein the calculated performance metrics and the determined retention risks for subsets of the employees are aggregated and provided.

13. The computer-program product of claim 12, wherein the aggregated employees correspond to one of: a group in the organization, a supervisor, a location, employees having an attribute, a time interval, and employees associated with a customer account.

14. The computer-program product of claim 11, wherein the computer-program mechanism further includes instructions for accessing, at another memory location in the computer system, external data for at least one other organization; and
wherein the determining of the retention risk is based on the external data.

15. The computer-program product of claim 14, wherein the external data includes one of: an unemployment rate in a region that includes the organization, hiring trends in the region, retention of employees by competitors of the organization, proximity of the competitors of the organization, compensation offered by the competitors, and activity of the employee on a social network.

16. The computer-program product of claim 11, wherein the calculated performance metric and the determined retention risk are evaluated for a set of time intervals; and
wherein the calculated performance metric and the determined retention risk correspond to variation in the set of time intervals.

17. The computer-program product of claim 11, wherein the calculated performance metric is relative to a mean performance metric of multiple employees of the organization.

18. A computer system, comprising:
a processor;
memory; and
a program module, wherein the program module is stored in the memory and configurable to be executed by the processor to analyze employee value and retention risk, the program module including:
instructions for accessing, at a memory location in the memory, organization data for an organization;
instructions for calculating a performance metric for an employee based on the organization data, wherein the calculation uses the processor that is coupled to the memory location and programmed to analyze the employee value and the retention risk;
instructions for determining, using the organization data, the retention risk for the employee;
instructions for providing the calculated performance metric and the determined retention risk; and
instructions for providing a retention suggestion and an associated cost-benefit analysis for the employee, wherein the cost-benefit analysis includes an expense associated with the retention suggestion and an estimated incremental retention time in response to the retention suggestion.

19. The computer system of claim 18, wherein the calculating and determining operations are repeated for multiple employees in the organization; and
wherein the calculated performance metrics and the determined retention risks for subsets of the employees are aggregated and provided

20. The computer system of claim 18, wherein the program module further includes instructions for accessing, at another memory location in the memory, external data for at least one other organization; and
wherein the determining of the retention risk is based on the external data.
